(19) United States
(12) Patent Application Publication
(10) Pub. No.: US 2021/0086495 A1
(43) Pub. Date: Mar. 25, 2021

(54) SYSTEM AND METHOD TO REDUCE CONDENSATION IN DIGITAL PRINTING PRESS

(71) Applicant: Stratagraph LLC, Oshkosh, WI (US)

(72) Inventor: Jeffrey A. Michels, Appleton, WI (US)

(73) Assignee: Stratagraph LLC, Oshkosh, WI (US)

(21) Appl. No.: 17/022,562

(22) Filed: Sep. 16, 2020

Related U.S. Application Data
(60) Provisional application No. 62/903,040, filed on Sep. 20, 2019.

(51) Int. Cl. B41F 3/52

(52) U.S. Cl. CPC B41F 3/52

(57) ABSTRACT

A method and system is provided for reducing condensation within an enclosed print arch of a printing press. The system includes at least one dehumidifier operable to create a dehumidified air flow directed into the print arch to reduce the humidity level within the print arch. The dehumidified air flow is selectively provided to a location at an infeed end of the print arch such that the movement of the print stock aids in moving the dehumidified air flow. The system further includes at least one exhaust fan that is operable to withdraw an exhaust air flow from within the enclosed print arch. The exhaust air flow can be vented to atmosphere or recirculated to the dehumidifier. A controller is used to control the operation of the dehumidifier and the exhaust fan based on signals from a temperature sensor and a humidity sensor each mounted within the enclosed print arch.

### CROSS REFERENCE TO RELATED APPLICATIONS

The present application is based on and claims priority to U.S. Provisional Patent Application Ser. No. 62/903,040, filed Sep. 20, 2019, the disclosure of which is incorporated herein by reference.

### BACKGROUND

The present disclosure generally relates to a digital printing press. More specifically, the present disclosure relates to a system for reducing condensation in a digital printing press to improve the quality of print.

In currently available digital wide web printing presses, an issue exists in which humidity builds up on printing bars during extended print jobs. The humidity building up on the print bars can collect and create water droplets that fall from the printing bar onto the printed web. Droplets of water falling on the printed web create smudges in the print and thus quality issues with the product being printed. Such problems can create wasted product and results in the need to print/produce more product than is necessary to meet the order of the customer. Such wasted product creates a loss in profit and reduces the overall printing capacity for companies utilizing the digital printing press.

In order to solve this problem, the present inventors have developed a system and method for reducing the amount of condensation that forms within the digital printing press, which results in the elimination of water droplets falling onto the printed web, thus increasing the efficiency of the press.

### SUMMARY

The present disclosure relates to a system and method for reducing condensation within a digital printing press. More specifically, the present disclosure utilizes one or more dehumidifiers to reduce the overall humidity level withing the print arch by injecting dried air into the printing press to remove moisture and thus prevent condensation.

The system and method of the present disclosure includes temperature and humidity probes positioned within the print arch of the printing press. The temperature and humidity probes provide information to a control unit that is operatively connected to one or more dehumidifiers and an exhaust fan. Based upon the sensed temperature and humidity within the print arch, the controller turns on the dehumidifier to create a flow of dried air. The flow of dried air is directed into the print arch at an area near the print bars. The dried air reducted the amount of moisture entrained in the air within the print arch to significantly reduce or eliminate condensation within the print arch.

The controller further operates one or more exhaust fans to pull air from within the print arch such that additional volumes of dried air can be injected into the print arch from the dehumidifier. The use of the dehumidifiers, control unit and exhaust fans creates a flow of dried air through the print arch to reduce the amount of moisture and thus reduce the amount of condensation.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a digital printing press utilizing the system for preventing condensation of the present disclosure;

FIG. 2 is a magnified view of the digital printing press illustrating the use of exhaust fans and dehumidifiers within the printing press; and

FIG. 3 is a schematic illustration showing the components utilized in the present disclosure.

### DETAILED DESCRIPTION

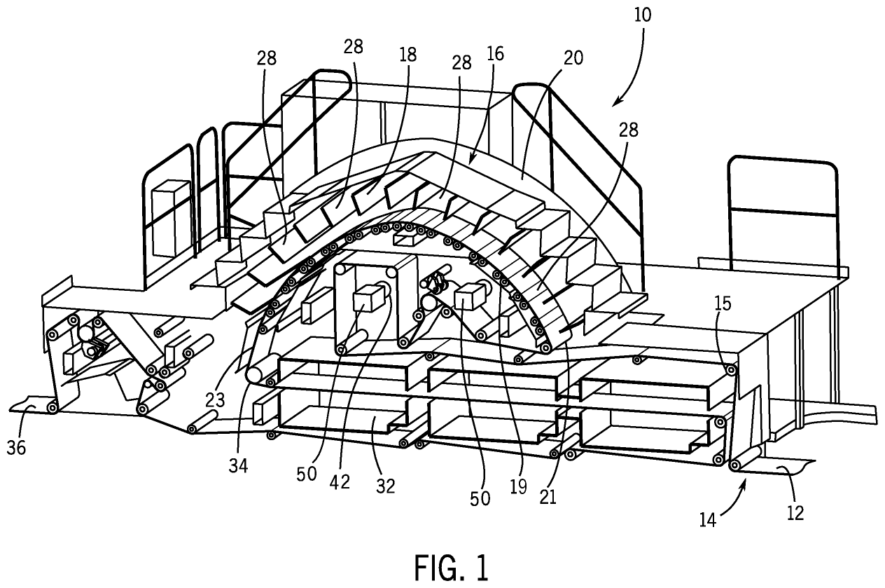

FIG. 1 illustrates a digital printing press 10 that incorporates the system and method of the present disclosure. The digital printing press 10 is shown as an example of a type of digital printing press that can be utilized with the system and method of the present disclosure. However, it should be understood that other types of digital printing presses could operate utilizing the subject matter of the present disclosure.

The digital printing press 10 receives a supply of material 12 to be printed, which is provided on a continuous web at the infeed end 14 of the printing press 10. The continuous sheet of unprinted stock material 12 passes over a series of rollers and enters into a print arch generally illustrated by reference numeral 16. Within the print arch 16, a series of print bars 18 prints specific images and colors on the web of material as the material moves through the print arch 16. The print bars 18 are positioned above the web of material as the web of material travels over a series of support rollers 19. The support rollers 19 are positioned in an arched configuration extending from an infeed end 21 to a discharge end 23.

As illustrated in FIG. 1, the print arch 16 includes an outer covering or hood 20 that prevents dust and other contaminants from contacting the material being printed during the printing process. The hood 20 can be formed from different types of materials and creates an enclosed environment which can cause the buildup of heat and humidity within the print arch 16. In prior systems, the buildup of heat and humidity within the print arch can cause condensation to form on the print bars and other metal components located within the print arch. The formation of condensation will eventually accumulate and create water droplets that can fall onto the web of material as the web of material is being printed.

In order to solve the problem of condensation within the print arch 16, the subject matter of the present disclosure utilizes one or more desiccant dehumidifiers that operate to inject dried air into the print arch 16 in the location near the print bars 18. The dehumidified air from the one or more dehumidifiers is directed throughout the print arch in the location near the print bars 18. The dehumidified air injected into the print arch 16 reduces the humidity level of the air within the print arch 16, which helps to reduce or hopefully eliminate any condensation that may occur within the print arch 16. Preferably, the dried air flow from the dehumidifier will be injected at a location near the infeed end 21 of the print arch such that the dried air will be pulled along with the moving web in the direction of the paper path toward the discharge end 23. In accordance with the present disclosure, the one or more dehumidifiers 50 will be located on the backside of the print arch. In FIG. 1, the two dehumidifiers 50 are shown in one contemplated location. Duct work (not shown) will direct the flow of dried air into the print arch at the selected locations.

In the embodiment shown, separate exhaust fans 42 will also be located within the print arch 16, in the area below the plurality of print bars 18, to create an exhaust flow of air that will draw and exhaust the hot and humid air from within the enclosed print arch 16. The dehumidifiers 50 and exhaust fans 42 can be separately controlled as will be discussed in further detail below.

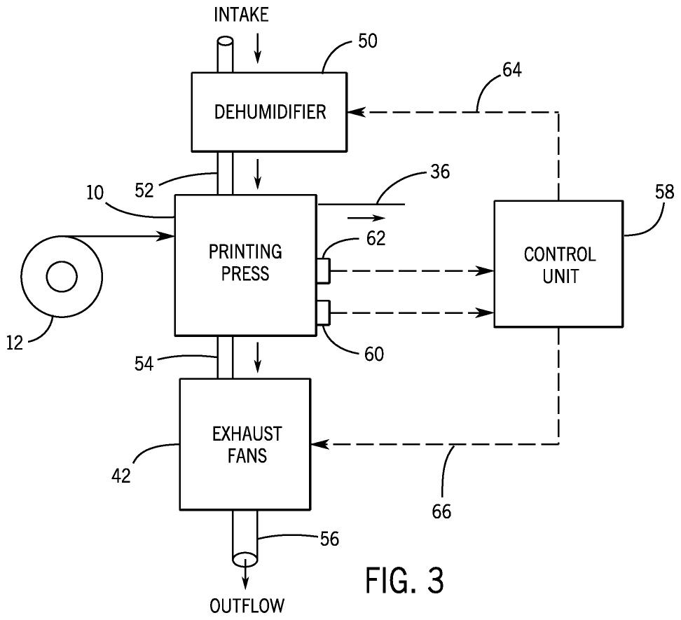

In accordance with the present disclosure, multiple temperature and humidity probes are positioned between the print bars 18, such as in the locations illustrated by reference numeral 28. The temperature and humidity probes 60, 62, shown in FIG. 3, measure the temperature and humidity within the print arch 16 and provide this information to a programmable PID controller 58. The programmable PID controller 58 monitors the temperature and humidity within the print arch 16 and turns on one or more desiccant dehumidifiers 50 when the temperature and humidity indicate that condensation may start to occur in the print arch. In addition, the controller 58 can selectively turn on/off the exhaust fans 42 based on the measured temperature and humidity within the print arch 16.

The one or more desiccant dehumidifiers 50 operate to create a supply of dried air that can be drawn into or pumped into the print arch 16 at one or more locations within the print arch 16 and typically close to the print bars 18. Since the web of material is moving through the print arch, the movement of the web of material helps to create an airflow within the print arch which can help move the dried air along with the movement of the web of material. As the dried air from the dehumidifiers is drawn or pumped into the print arch and moved within the print arch, the dried air reduces the overall humidity level within the print arch, thus reducing or preventing condensation. The elimination of the condensation with the print arch reduces the amount of water droplets that would otherwise fall onto the printed product as the web of material moves through the print arch.

Once the web of material has been printed, the web of material enters into a dryer section 32 at the infeed 34 of the dryer section 32. The web of material passes through the dryer section and exits the printing press as shown at the outfeed end 36.

In addition to the use of dehumidifiers and temperature and humidity probes, the system of the present disclosure further includes one or more exhaust fans 42 that are installed inside the print arch, below the print bar area. The exhaust fans operate to exhaust the hot and humid air from the internal print area and thus create an airflow out of the print arch 16 that helps to draw in the dried air created by the one or more dehumidifiers 50.

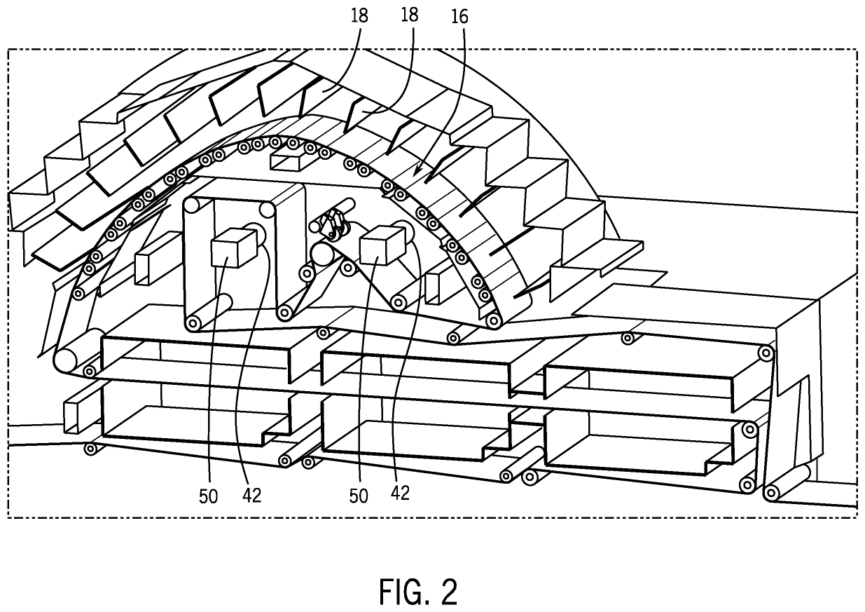

FIG. 2 illustrates a pair of exhaust fans 42 located beneath the print bars 18. Each of the exhaust fans 42 is operable to create a flow of air leaving the print arch 16. The outflow of air created by the exhaust fans 42 helps to draw the dried air from the dehumidifiers into the print arch to create a circulation of dried air that helps eliminate the formation of condensation within the print arch, such as on the print bars 18.

Although exhaust fans 42 are shown in specific locations in FIG. 2, it should be understood that the exhaust fans 42 could be located at different locations within the print arch 16 to create a flow of air that exits the print arch and helps to create a negative pressure that helps to draw dehumidified air into the print arch. The inflow of dehumidified air from the dehumidifiers reduces the overall humidity of the air within the print arch. In one embodiment of the present disclosure, the flow of air created by the exhaust fans can be vented to atmosphere. In an alternate embodiment, the flow of air drawn from within the print arch can be directed to pass through the one or more dehumidifiers to create a closed loop system that allows the dehumidifier to remove humidity from the air within the print arch. Such as close loop system may be desirable in a very humid climate to increase the efficiency of the dehumidifiers.

Various different types of dehumidifiers could be utilized while operating within the scope of the present disclosure. It is contemplated that a desiccant dehumidifier would be one preferred type of dehumidifier that could be utilized. However, different types of dehumidifiers could operate in the same manner to prevent the creation of condensation within the print arch.

FIG. 3 is a schematic illustration of the operating components of the present disclosure. As illustrated in FIG. 3, the printing press 10 receives the roll of material 12 and operates to print the required images on the material as the material flows through the printing press 10. The printed roll material exits at the outfeed end 36 where the printed material can be further processed as is well known.

The system includes at least one dehumidifier 50 that receives an intake flow of fresh air. The dehumidifier 50 operates to remove moisture from the intake air and creates a dried air flow through the conduit 52. As described previously, the conduit 52 is connected to the printing press such that the dried air is directed into the printing press to reduce the overall humidity and reduce the moisture of the air within the printing press. One or more exhaust fans 42 create an outflow of air through the conduit 54. The outflow airstream includes the air that was in the print art, which has a high level of humidity. The outflow air 56 can then be either vented to atmosphere or redirected as the intake air into the dehumidifier 50, as previously described.

The system of the present disclosure further includes a control unit 58 that receives input signals from one or more temperature sensors 60 and one or more humidity sensor 62. Although the temperature sensors 60 and humidity sensors 62 are shown as separate components, it should be understood that the temperature sensors 60 and humidity sensors 62 could be combined.

Based upon the temperature and humidity information received from the sensors, the control unit 58 can selectively operate the dehumidifier 50 and the exhaust fans 42. As illustrated, the control unit 58 is operatively connected to both the dehumidifier 50 and the exhaust fans 42 through a pair of control lines 64 and 66. In this manner, the control unit 58 is able to selectively control the operation of both the dehumidifier 50 and exhaust fans 42 based upon input signals received from the temperature and humidity sensors.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system for use with a printing press including an enclosed print arch having a plurality of print bars, the system comprising:
a dehumidifier operable to create a dehumidified airflow supplied to the enclosed print arch;
an exhaust fan operable to exhaust an exhaust airflow from the enclosed print arch;
a humidity sensor positioned within the enclosed print arch;
a temperature sensor positioned within the enclosed print arch; and
a controller in communication with the dehumidifier, the exhaust fan, the humidity sensor and the temperature sensor, wherein the controller is operable to control the operation of the dehumidifier.

2. The system of claim 1 wherein the controller is operable to control the operation of the exhaust fan.

3. The system of claim 2 wherein the controller controls the operation of the dehumidifier and the exhaust fan based on a temperature signal from the temperature sensor and a humidity signal from the humidity sensor.

4. The system of claim 3 wherein the system includes a plurality of dehumidifiers.

5. The system of claim 3 wherein the system includes a plurality of exhaust fans.

6. The system of claim 1 wherein the dehumidifier is located at an infeed end of the print arch.

7. The system of claim 1 wherein the exhaust airflow from the exhaust fan is directed to the dehumidifier.

8. A printing press comprising:
an enclosed print arch having a plurality of print bars;
a dehumidifier operable to create a dehumidified airflow supplied to the enclosed print arch;
an exhaust fan operable to exhaust an exhaust airflow from the enclosed print arch;
a humidity sensor positioned within the enclosed print arch;
a temperature sensor positioned within the enclosed print arch; and
a controller in communication with the dehumidifier, the exhaust fan, the humidity sensor and the temperature sensor, wherein the controller is operable to control the operation of the dehumidifier.

9. The printing press of claim 8 wherein the controller is operable to control the operation of the exhaust fan.

10. The printing press of claim 9 wherein the controller controls the operation of the dehumidifier and the exhaust fan based on a temperature signal from the temperature sensor and a humidity signal from the humidity sensor.

11. The printing press of claim 10 wherein the printing press includes a plurality of dehumidifiers.

12. The printing press of claim 10 wherein the printing press includes a plurality of exhaust fans.

13. The printing press of claim 8 wherein the dehumidifier is located at an infeed end of the print arch.

14. The printing press of claim 8 wherein the exhaust airflow from the exhaust fan is directed to the dehumidifier.

15. A method of reducing condensation within a printing press including an enclosed print arch having a plurality of print bars, the method comprising:
providing a dehumidifier in air flow communication with the enclosed print arch, the dehumidifier being operable to create a dehumidified airflow;
providing an exhaust fan in air flow communication with the enclosed print arch, the exhaust fan being operable to create an exhaust airflow;
providing a controller operable to control the operation of the dehumidifier and the exhaust fan; and
operating the dehumidifier and the exhaust fan to reduce the humidity level within the enclosed print arch.

16. The method of claim 15 further comprising the steps of:
positioning a temperature sensor to determine the temperature within the enclosed print arch;
positioning a humidity sensor to determine the humidity within the enclosed print arch; and
operating the dehumidifier and the exhaust fan to reduce the humidity level within the enclosed print arch based on the temperature and the humidity.

17. The method of claim 15 wherein the dehumidifier is located at an infeed end of the print arch.

18. The method of claim 15 wherein a plurality of dehumidifiers are provided.
